(19) United States
(12) Patent Application Publication
(10) Pub. No.: US 2026/0099251 A1
(43) Pub. Date: Apr. 9, 2026

(54) METHODS AND APPARATUS FOR DDR6 COMMAND ADDRESS AND CHIP SELECT TRAINING

(71) Applicant: Intel Corporation, Santa Clara, CA (US)

(72) Inventors: Saravanan Sethuraman, Portland, OR (US); Caroline McClendon Grimes, Waxhaw, NC (US)

(73) Assignee: Intel Corporation, Santa Clara, CA (US)

(21) Appl. No.: 19/415,263

(22) Filed: Dec. 10, 2025

Related U.S. Application Data
(60) Provisional application No. 63/852,519, filed on Jul. 28, 2025.

(51) Int. Cl. G06F 3/06

(52) U.S. Cl. CPC G06F 3/061; G06F 3/0659; G06F 3/0673

(57) ABSTRACT

Methods and apparatus for DDR6 command address and chip select training are disclosed. An example apparatus comprising memory including a first register including a first voltage reference setting and a second register including a second voltage reference setting, the memory to determine logic states of signals based on the first voltage reference, and at least one processor circuit coupled to the memory, the at least one processor circuit configured to cause the memory to enter a training mode, where the memory determines the logic states of the signals based on the second voltage reference, adjust the second voltage reference setting based on first verification data of the at least one processor circuit and second verification data of the memory, and after verification of the second voltage reference setting based on the first verification data and the second verification data, store the second voltage reference setting in the first register.

### RELATED APPLICATION

This patent claims the benefit of U.S. Provisional Patent Application No. 63/852,519, which was filed on July 28, 2025. U.S. Provisional Patent Application No. 63/852,519 is hereby incorporated herein by reference in its entirety. Priority to U.S. Provisional Patent Application No. 63/852,519 is hereby claimed.

### BACKGROUND

Sixth-generation Double Data Rate (DDR6) memory training is a calibration process that aligns the interface timing, voltage references, and signal integrity parameters between memory controllers and dynamic random access memory (DRAM) devices. It ensures reliable high-speed operation by adjusting factors such as clock alignment, data-strobe timing, impedance, and voltage reference settings during initialization.

### BRIEF DESCRIPTION OF THE DRAWINGS

FIG. 1 is a block diagram of an example environment in which example host memory controller circuitry operates to train an example memory.

FIG. 2 is a block diagram of an example implementation of the host memory controller circuitry of FIG. 1.

FIG. 3 is a diagram that shows example signals generated by the host memory controller circuitry to be received by the memory of FIG. 1.

FIG. 4 is a diagram that shows example signals between the host memory controller circuitry and the memory of FIG. 1 during chip select training.

FIG. 5 is a diagram that shows example signals between the host memory controller circuitry and the memory of FIG. 1 during command address training.

FIG. 6 is a flowchart representative of example machine readable instructions and/or example operations that may be executed, instantiated, and/or performed by example programmable circuitry to implement the host memory controller circuitry of FIG. 2.

FIG. 7 is a block diagram of an example processing platform including programmable circuitry structured to execute, instantiate, and/or perform the example machine readable instructions and/or perform the example operations of FIG. 6 to implement the host memory controller circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIG. 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Dynamic Random Access Memory (DRAM) devices that operate in accordance with the sixth-generation Double Data Rate (DDR6) standard include multi-gigabit signaling interfaces that require precise timing alignment, voltage referencing, and calibration operations to ensure reliable high-speed data transfer. As interface speeds increase, the timing margins associated with read and write operations shrink, and variations introduced by manufacturing tolerances, temperature drift, supply noise, and channel impedance become more pronounced. To compensate for these variations, DDR6 devices perform a set of initialization and calibration procedures collectively referred to as training.

Training operations in DDR6 systems generally occur during power-up, reset, or other defined initialization sequences executed by the memory controller. These procedures may include establishing valid reference voltages for data detection (e.g., voltage reference (VREF) training) and aligning clock and strobe signals (e.g., clock (CK) and data strobe (DQS) signals. During these steps, the controller issues mode register commands and controlled data patterns that enable the DRAM to measure timing offsets, adjust internal delay elements, and converge on settings that yield stable data capture across the expected operating conditions.

Examples described herein provide for a chip select training mode (CSTM) to ensure proper timing alignment and signal integrity for operations that rely on chip-select signaling. The CSTM places the DRAM device into a controlled calibration state in which a memory controller can adjust the timing relationship between the chip-select (CS) signals and associated command, address, clock, and strobe domains. During the CSTM, the memory controller issues defined training patterns and mode register operations that allow the DRAM to evaluate CS timing relative to CK transitions, determine required delay compensation, and establish margins that support reliable multi-gigabit operation. By isolating chip-select behavior within a dedicated training mode, DDR6 devices can correct skew introduced by routing differences, package variations, and temperature-dependent drift, which improves command decoding accuracy and maintains robust operation across wide data buses and elevated signaling speeds.

Examples described herein further provide for a command/address training mode (CATM) to calibrate the timing relationship between the command/address (CA) bus and the primary clock domain. When the DRAM enters the CATM, normal command execution is suspended and the device instead interprets incoming CA patterns as training stimuli. The memory controller transmits predefined sequences on the command and address lines while sweeping timing offsets or adjusting delay elements associated with the CK, CS, and CA paths. By observing the DRAM’s training responses, the controller identifies the optimal sampling point at which the DRAM can reliably decode command and address information across process, voltage, temperature, and routing variations. CATM thereby compensates for skew between CA bits, corrects flight-time imbalances across the channel, and establishes stable margins necessary for multi-gigabit DDR6 operation.

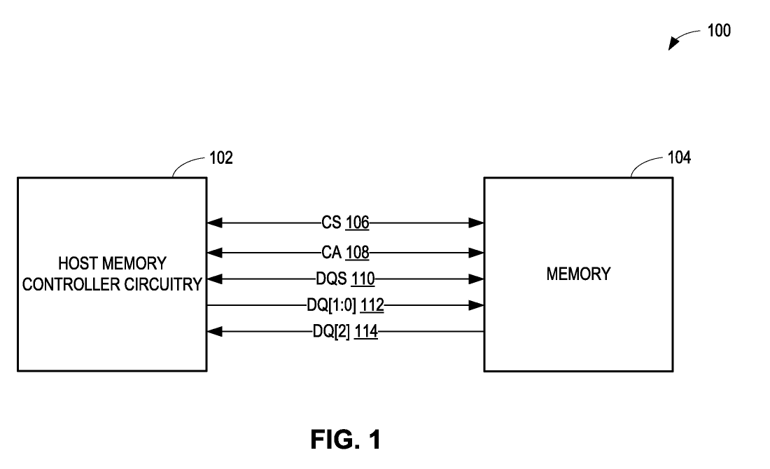

FIG. 1 is a block diagram of an example environment 100 in which example host memory controller circuitry 102 operates to train an example memory 104. Specifically, the host memory controller circuitry 102 performs chip select training in a chip select training mode (CSTM) and command/address training in a command/address training mode (CATM). In the illustrated example, the host memory controller circuitry 102 is coupled to the memory 104 by a chip select lane 106, a command address lane 108, a data strobe lane 110, a first data lane 112, and a second data lane 114. The example memory 104 is a DRAM device operating in accordance with DDR6 standard. The example environment 100 can include a desktop personal computer, a laptop computer, a mobile device, or more generally, any computing device which utilizes a DRAM device.

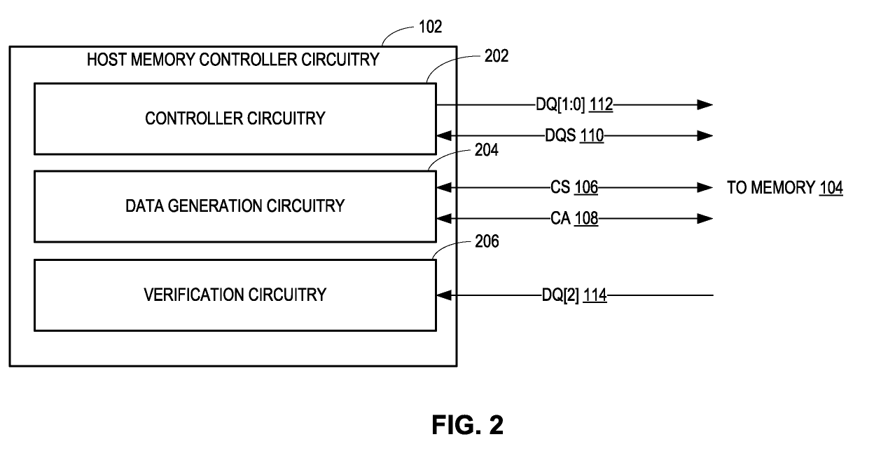

FIG. 2 is a block diagram of an example implementation of the host memory controller circuitry 102 of FIG. 1 to train the memory 104. The host memory controller circuitry 102 includes example controller circuitry 202, example data generation circuitry 204, and example verification circuitry 206. The controller circuitry 202 is coupled to the memory 104 via the first data lane 112 and the data strobe lane 110. The data generation circuitry 204 is coupled to the memory 104 via the chip select lane 106 and the command address lane 108. Further, the verification circuitry 206 is coupled to the memory 104 via the second data lane 114.

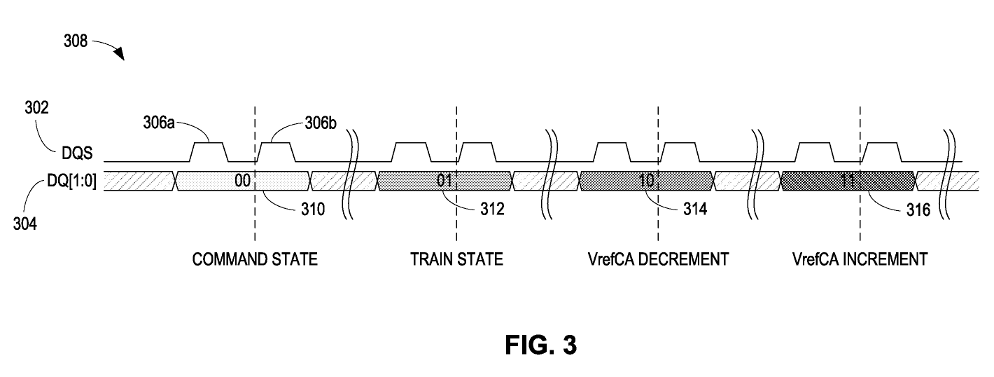

The controller circuitry 202 generates commands to the memory 104 to cause the memory 104 to change modes or to change settings (e.g., voltage reference values, timing values, etc.). Further, the controller circuitry 202 generates a data strobe signal to be received by the memory 104 via the data strobe lane 110. The memory 104 uses the data strobe signal to sample the first data lane 112. The controller circuitry 202 issues commands to the memory 104 via the first data lane 112. Commands issued by the controller circuitry 202 will be described in further detail in reference to FIG. 3.

FIG. 3 is a diagram that shows example signals (e.g., commands) generated by the controller circuitry 202 to be received by the memory 104. The illustrated example of FIG. 3 includes an example data strobe signal 302 and an example first data signal 304. The controller circuitry 202 can transmit the data strobe signal 302 via the data strobe lane 110 and the first data signal 304 via the first data lane 112 to the memory 104. The data strobe signal 302 includes two pulses 306a-b per period 308. Further, in the illustrated example, the first data signal 304 includes first, second, third, and fourth commands 310-316 associated with a command state command, a train state command, a voltage reference decrement command, and a voltage reference increment command, respectively. The command state command causes the memory 104 to enter a command state. The train state command causes the memory 104 to enter a train state. Further, the voltage reference decrement and increment commands cause the memory 104 to adjust a voltage reference associated with the memory 104. In some examples, the controller circuitry 202 can command specific voltage reference values. For example, the controller circuitry 202 can generate a specific strobe signal via the data strobe lane 110 to indicate that a specific voltage reference value will be transmitted over the first data lane 112. In some examples, the controller circuitry 202 can send the specific voltage reference value over the first data lane 112 in multiple stages. For example, the controller circuitry 202 can send a first portion of the specific voltage reference value in a first stage, and a second portion in a second stage.

Returning now to FIG. 2, the controller circuitry 202 generates commands (e.g., signals) to the data generation circuitry 204 to cause the verification data generation circuitry 204 to generate verification data based on the memory 104 being in either the CSTM or CATM. For example, the controller circuitry 202 can generate a first or second data verification generation signal to the data generation circuitry 204 based on the memory being in the CSTM or CATM. Further, the controller circuitry 202 is configured to receive a verification signal from the verification circuitry 206. For example, the controller circuitry 202 can receive a first verification signal from the verification circuitry 206 indicating that verification was successful, or a second verification signal from the verification circuitry 206 indicating that verification was unsuccessful.

The data generation circuitry 204 generates and provides verification data to the memory 104. In some examples, the data generation circuitry 204 can provide first verification data to the memory 104 after receiving the first data verification generation signal from the controller circuitry 202. Further, in some examples, the data generation circuitry 204 can provide second verification data to the memory 104 after receiving the second data verification signal from the controller circuitry 202.

The first verification data is associated with the CSTM. The data generation circuitry 204 provides the first verification data to the memory 104 via the chip select lane 106. The first verification data includes a clock like pattern (e.g., a series of digital ones and zeros). In some examples, the data generation circuitry 204 further provides the first verification data to the controller circuitry 202. In such examples, the controller circuitry 202 can provide a data strobe signal via the data strobe lane 110 to enable the memory 104 to effectively sample the first verification data.

The second verification data is associated with the CATM. The data generation circuitry 204 provides the second verification data to the memory 104 via the command address lane 108. The second verification data includes a pseudo randomly generated number, for example a twenty bit number. In some examples, the pseudo randomly generated number can be generated using a pseudo random binary sequence (PRBS) with a twenty bit linear feedback shift register (LFSR). In some examples, the pseudo randomly generated number is generated based on predetermined parameters (e.g., a seed). Further, in such example, the pseudo randomly generated number can also be generated by the memory 104 based on the same seed. This enables the memory 104 to generate the pseudo randomly generated number and compare it to the pseudo randomly generated number received from the data generation circuitry 204.

The verification circuitry 206 receives a verification signal from the memory 104 via the second data line 114. For example, the verification circuitry 206 can receive a first verification signal indicating that a voltage reference setting associated with the memory 104 needs to be updated (e.g., adjusted). Further, the verification circuitry 206 can receive a second verification signal indicating that the voltage reference setting is within acceptable parameters (e.g., the voltage reference setting is calibrated).

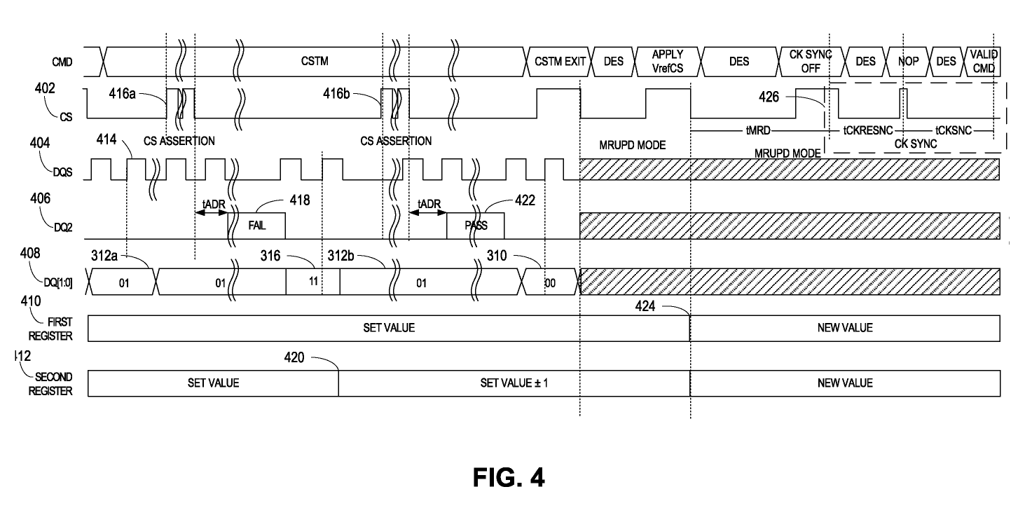

FIG. 4 is a diagram that shows example signals between the host memory controller circuitry 102 and the memory 104 of FIG. 1 during chip select training. FIG. 4 includes example chip select (CS) data 402, example strobe data (DQS) 404, example second data (DQ[2]) 406, and example first data (DQ[1:0]) 408. The CS data 402, the strobe data 404, the second data 406, and the first data 408 correspond to the chip select lane 106, the data strobe lane 110, the second data lane 114, and the first data lane 112, respectively. FIG. 4 further includes a representation of a first voltage reference value in a first register 410 of the memory 104 and a second voltage reference value in a second register 412 of the memory 104.

In the illustrated example, the controller circuitry 202 issues a train state command 312a to cause the memory 104 to enter a training state. The memory 104 samples the first data lane 112 at a second rising edge 414 of the data strobe signal 404. Next, the controller circuitry 202 causes the data generation circuitry 204 to generate first verification data 416a and provide (e.g., transmit) it to the memory 104 via the chip select lane 106. The memory 104 then measures the first verification data 416 before generating a first verification signal 418 to the verification circuitry 206. In the illustrated example, the first verification signal 418 indicates that the measurements taken by the memory 104 of the first verification data 416 were not acceptable (e.g., the second voltage reference value is not calibrated). Next, the verification circuitry 206 provides the first verification signal 418 to the controller circuitry 202. The controller circuitry 202 then issues the voltage reference increment command 316 to the memory 104 based on the first verification signal 418 via the first data lane 112. While in the illustrated example of FIG. 4 the controller circuitry 202 issues the voltage reference increment command 316, in some examples, the controller circuitry 202 can issue the voltage reference decrement command 314. Whether the controller circuitry 202 issues the voltage reference increment command 314 or the voltage reference decrement command 316 is based on the first verification signal 418.

After the memory 104 receives the voltage reference increment command 316, the memory 104 increments the second voltage reference setting as shown at 420. Further, the controller circuitry 202 then issues the train state command 312b causing the memory 104 to enter the training state. Next, the controller circuitry 202 causes the data generation circuitry 204 to generate the first verification data 416b and provide (e.g., transmit) it to the memory 104 via the chip select lane 106. The memory 104 then measures the second verification data 416b before generating a second verification signal 422 to the verification circuitry 206. In the illustrated example, the second verification signal 422 indicates that the measurements taken by the memory 104 of the second verification data 420 were acceptable (e.g., the second reference voltage value is calibrated). Next, the verification circuitry 206 provides the second verification signal 422 to the controller circuitry 202. The controller circuitry 202 then issues a command state command 310 to cause the memory 104 to enter a command state (e.g., exit the CSTM) based on the second verification signal 422 indicating chip select training was successful.

Further, in some examples, after the memory 104 enters the command state the controller circuitry 202 causes the memory 104 to store the second reference voltage value in the first register 410 at 424. The controller circuitry 202 then causes the memory 104 to perform a clock synchronization operation after the second reference voltage value has been stored in the first register 410 at 426.

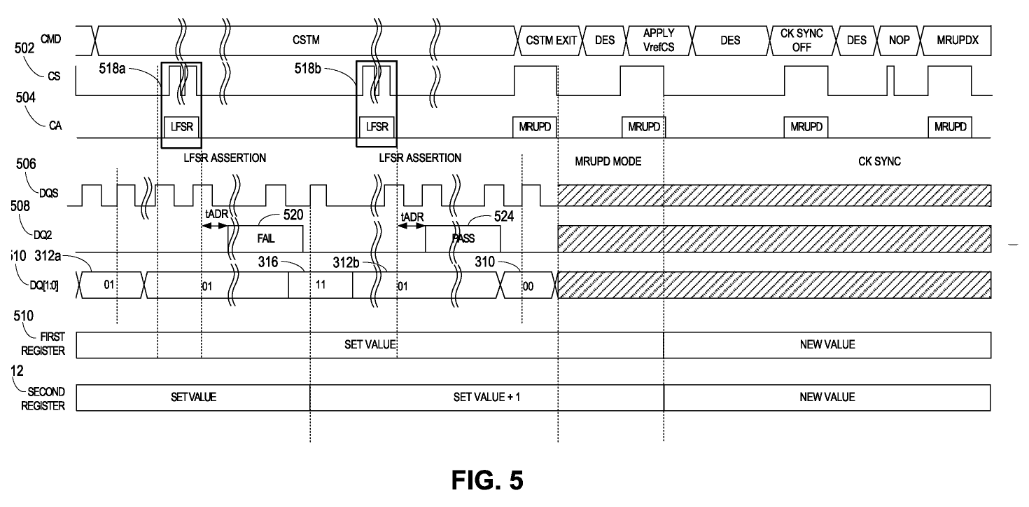

FIG. 5 is a diagram that shows example signals between the host memory controller circuitry 102 and the memory 104 of FIG. 1 during command address training. FIG. 4 includes example chip select (CS) data 502, example command address (CA) data 504, example strobe data (DQS) 506, example second data (DQ[2]) 508, and example first data (DQ[1:0]) 510. The CS data 502, the CA data 504, the strobe data 506, the second data 508, and the first data 510 correspond to the chip select lane 106, the command address lane 108, the data strobe lane 110, the second data lane 114, and the first data lane 112, respectively. FIG. 5 further includes a representation of a first voltage reference value 512 in a first register of the memory 104 and a second voltage reference value 514 in a second register of the memory 104.

In the illustrated example, the controller circuitry 202 issues a train state command 312a to cause the memory 104 to enter a training state. The memory 104 samples the first data lane 112 at a second rising edge 516 of the data strobe signal 506. Next, the controller circuitry 202 causes the data generation circuitry 204 to generate second verification data 518a and provide (e.g., transmit) it to the memory 104 via the chip select lane 106 and the command address lane 108. The memory 104 then measures the second verification data 518a before generating a first verification signal 520 to the verification circuitry 206. In the illustrated example, the first verification signal 520 indicates that the measurements taken by the memory 104 of the first verification data 518a were not acceptable (e.g., the second voltage reference value is not calibrated). Next, the verification circuitry 206 provides the first verification signal 518a to the controller circuitry 202. The controller circuitry 202 then issues the voltage reference increment command 316 to the memory 104 based on the first verification signal 518a via the first data lane 112. While in the illustrated example of FIG. 5 the controller circuitry 202 issues the voltage reference increment command 316, in some examples, the controller circuitry 202 can issue the voltage reference decrement command 314. Whether the controller circuitry 202 issues the voltage reference increment command 314 or the voltage reference decrement command 316 is based on the first verification signal 518a.

After the memory 104 receives the voltage reference increment command 316, the memory 104 increments the second voltage reference setting as shown at 522. Further, the controller circuitry 202 then issues the train state command 312b causing the memory 104 to enter the training state. Next, the controller circuitry 202 causes the data generation circuitry 204 to generate the second verification data 518b and provide (e.g., transmit) it to the memory 104 via the chip select lane 106 and the command address lane 108. The memory 104 then measures the second verification data 518b before generating a second verification signal 524 to the verification circuitry 206. In the illustrated example, the second verification signal 524 indicates that the measurements taken by the memory 104 of the second verification data 524 were acceptable (e.g., the second reference voltage value is calibrated). Next, the verification circuitry 206 provides the second verification signal 524 to the controller circuitry 202. The controller circuitry 202 then issues a command state command 310 to cause the memory 104 to enter a command state (e.g., exit the CATM) based on the second verification signal 524 indicating command address training was successful. Further, in some examples, after the memory 104 enters the command state the controller circuitry 202 causes the memory 104 to store the second reference voltage value 514 in the first register 410 at 526.

The host memory controller circuitry 102 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the host memory controller circuitry of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

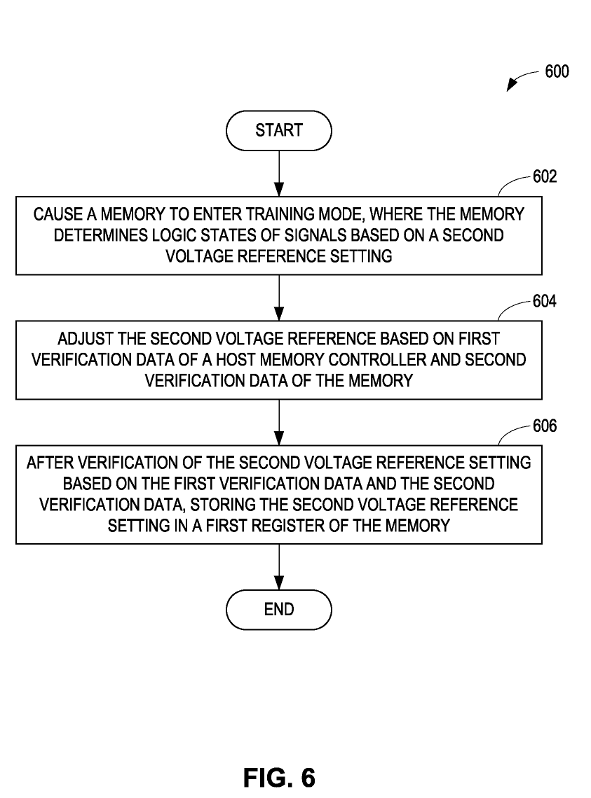

In some examples, the controller circuitry 202 is instantiated by programmable circuitry executing controller circuitry instructions and/or configured to perform operations such as those represented by the flowchart(s) of FIG. 6.

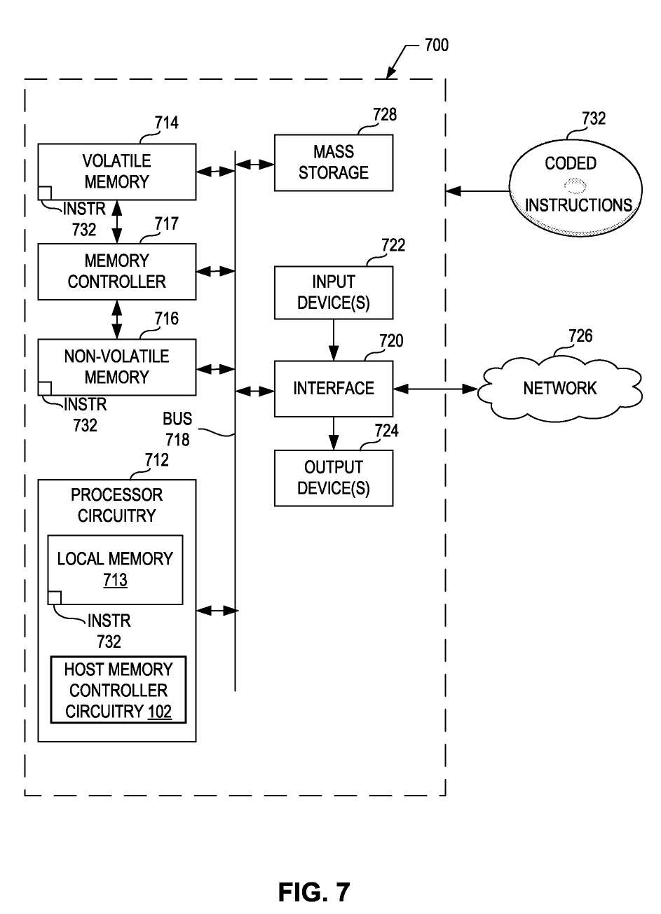

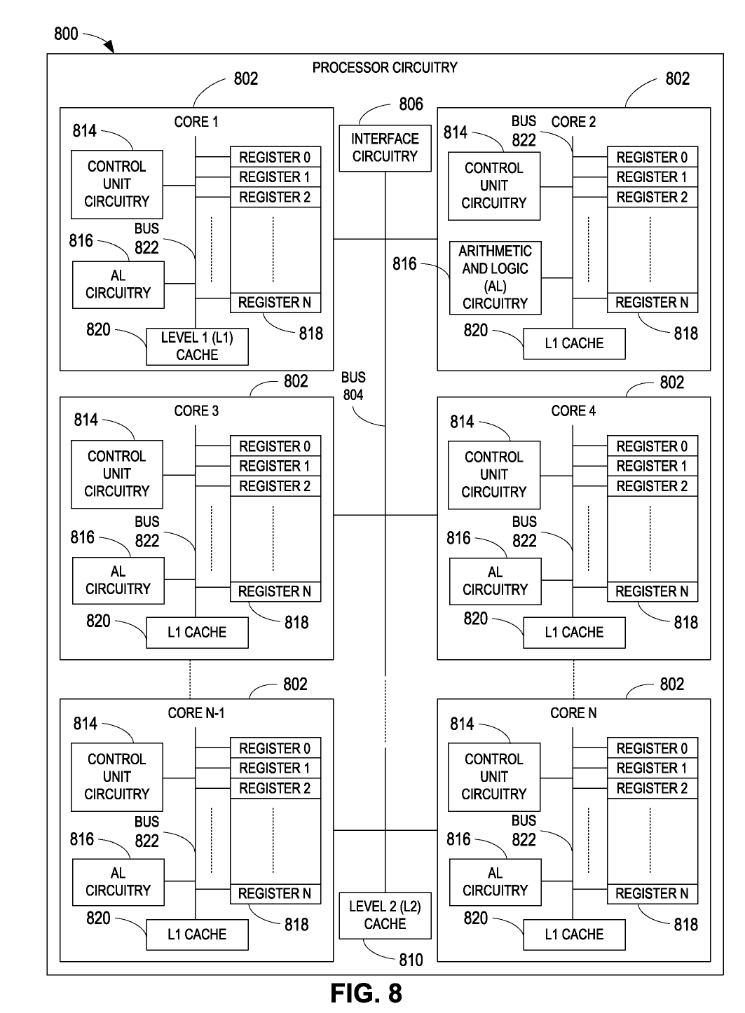

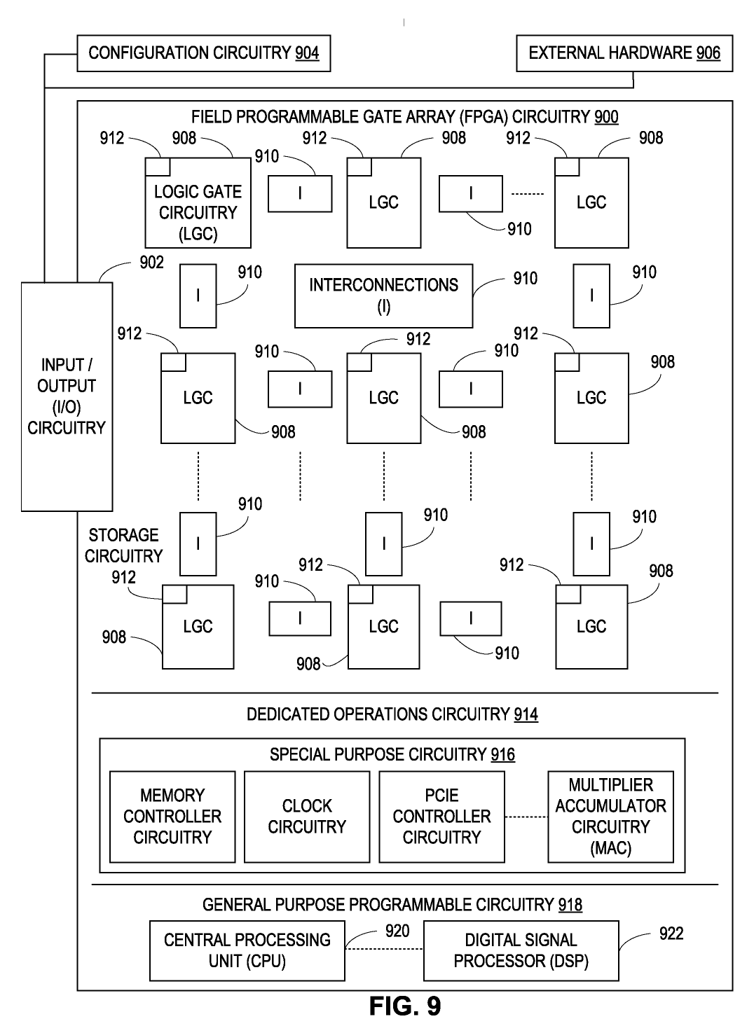

In some examples, the host memory controller circuitry 102 includes means for controlling. For example, the means for controlling may be implemented by controller circuitry 202. In some examples, the controller circuitry 202 may be instantiated by programmable circuitry such as the example programmable circuitry 712 of FIG. 7. For instance, the controller circuitry 202 may be instantiated by the example microprocessor 800 of FIG. 8 executing machine executable instructions such as those implemented by at least blocks 602, 604, and 606 of FIG. 6. In some examples, controller circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the controller circuitry 202 may be instantiated by any other combination of hardware, software, and/or firmware. For example, the controller circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data generation circuitry 204 is instantiated by programmable circuitry executing data generation circuitry instructions and/or configured to perform operations such as those represented by the flowchart(s) of FIG. 6.

In some examples, the host memory controller circuitry 102 includes means for generating data. For example, the means for generating data may be implemented by the data generation circuitry 204. In some examples, the data generation circuitry 204 may be instantiated by programmable circuitry such as the example programmable circuitry 712 of FIG. 7. For instance, the data generation circuitry 204 may be instantiated by the example microprocessor 800 of FIG. 8 executing machine executable instructions such as those implemented by at least blocks 604 and 606 of FIG. 6. In some examples, the data generation circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the data generation circuitry 204 may be instantiated by any other combination of hardware, software, and/or firmware. For example, the data generation circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the verification circuitry 206 is instantiated by programmable circuitry executing verification circuitry instructions and/or configured to perform operations such as those represented by the flowchart(s) of FIG. 6.

In some examples, the host memory controller circuitry 102 includes means for verifying data. For example, the means for verifying may be implemented by the verification circuitry 206. In some examples, the verification circuitry 206 may be instantiated by programmable circuitry such as the example programmable circuitry 712 of FIG. 7. For instance, the verification circuitry 206 may be instantiated by the example microprocessor 800 of FIG. 8 executing machine executable instructions such as those implemented by at least blocks 604 and 606 of FIG. 6. In some examples, the verification circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the verification circuitry 206 may be instantiated by any other combination of hardware, software, and/or firmware. For example, the verification circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the host memory controller circuitry of FIG. 1 is illustrated in FIG. 2, one or more of the elements, processes, and/or devices illustrated in FIG. 2 may be combined, divided, re-arranged, omitted, eliminated, and/or implemented in any other way. Further, the example controller circuitry 202, the example data generation circuitry 204, the example verification circuitry 206, and/or, more generally, the example host memory controller circuitry of FIG. 2, may be implemented by hardware alone or by hardware in combination with software and/or firmware. Thus, for example, any of the example controller circuitry 202, the example data generation circuitry 204, the example verification circuitry 206, and/or, more generally, the example host memory controller circuitry, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example host memory controller circuitry of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the host memory controller circuitry of FIG. 2 and/or representative of example operations which may be performed by programmable circuitry to implement and/or instantiate the host memory controller circuitry of FIG. 2, are shown in FIG. 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 6, many other methods of implementing the example host memory controller circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to perform CS training or CA training. The example machine-readable instructions and/or the example operations 600 of FIG. 6 begin at block 602, at which the controller circuitry 202 causes the memory 104 to enter a training mode, where the memory 104 determines logic states of signals based on a second voltage reference setting in a second register of the memory 104. In some examples, while not in the training mode, the memory 104 determines the logic states of the signals based on a first voltage reference setting in a first register of the memory 104.

At block 604 the controller circuitry 202 adjusts the second voltage reference based on first verification data of the host memory controller circuitry 102 and second verification data of the memory 104. For example, the first verification data can be generated by the data generation circuitry 204, and verified by the verification circuitry 206. The second verification data can be generated by the memory 104 using the same parameters used by the data generation circuitry 204 to generate the first verification data. For example, the first verification data can be the same as the second verification data.

At block 606 after verification of the second voltage reference setting based on the first verification and the second verification data, the controller circuitry 202 causes the second voltage reference setting to be stored in the first register of the memory 104.

FIG. 7 is a block diagram of an example programmable circuitry platform 700 structured to execute and/or instantiate the example machine-readable instructions and/or the example operations of FIG. 6 to implement the host memory controller circuitry of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the controller circuitry 202, the data generation circuitry 204, and the verification circuitry 206.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIG. 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIG. 6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIG. 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 6. As such, the FPGA circuitry 900 may be configured and/or structured to effectively instantiate some or all of the operations/functions corresponding to the machine readable instructions of the flowchart(s) of FIG. 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIG. 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIG. 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIG. 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. [Flowcharts], and/or an ASIC may be configured and/or structured to perform third operation(s)/function(s) corresponding to a third portion of the machine readable instructions represented by the flowcharts of FIG. 6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

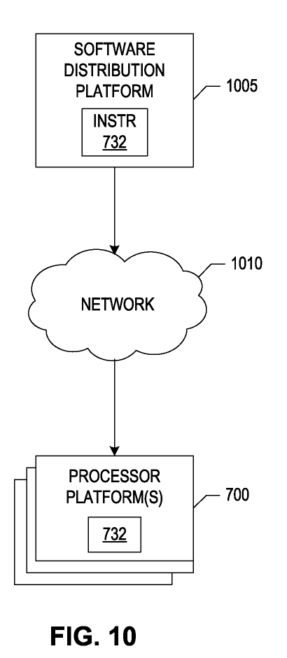

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIG. 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. [Flowcharts], may be downloaded to the example programmable circuitry platform 700, which is to execute the machine readable instructions 732 to implement the host memory controller circuitry. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable command address and chip select training for DDR6 memory. Further examples and combinations thereof include the following:

Example 1 includes an apparatus comprising memory including a first register including a first voltage reference setting and a second register including a second voltage reference setting, the memory to determine logic states of signals based on the first voltage reference, and at least one processor circuit coupled to the memory, the at least one processor circuit configured to cause the memory to enter a training mode, where the memory determines the logic states of the signals based on the second voltage reference, adjust the second voltage reference setting based on first verification data of the at least one processor circuit and second verification data of the memory, and after verification of the second voltage reference setting based on the first verification data and the second verification data, store the second voltage reference setting in the first register.

Example 2 includes the apparatus of example 1, wherein the first verification data includes a clock signal and wherein the second verification data includes a measurement of a pulse width of the clock signal by the memory.

Example 3 includes the apparatus of any one or more of examples 1-2, wherein the first verification data includes a pseudo randomly generated number and wherein the second verification data includes a comparison of the pseudo randomly generated number and the first verification data by the memory.

Example 4 includes the apparatus of any one or more of examples 1-3, wherein one or more of the at least one processor circuit is to cause the memory to perform a clock synchronization operation after storing the first voltage reference setting in the first register.

Example 5 includes the apparatus of any one or more of examples 1-4, wherein the one or more of the at least one processor circuit is to issue a first command to a first data lane and a second data lane of a plurality of data lanes of the memory to cause the memory to enter the training mode.

Example 6 includes the apparatus of example 5, wherein the memory samples the first data lane and the second data lane after a second rising edge of a clock signal associated with the at least one processor circuit occurs.

Example 7 includes the apparatus of any one or more of examples 5-6, wherein one or more of the at least one processor circuit is to issue at least one of a second command or a third command to the first data lane and the second data lane to adjust the second reference voltage.

Example 8 includes the apparatus of any one or more of examples 5-7, wherein one or more of the at least one processor circuit is to adjust the second reference voltage setting based on a verification signal from a third data lane of the plurality of data lanes of the memory.

Example 9 includes a non-transitory machine readable storage medium comprising instructions to cause programmable circuitry to cause a memory to enter a training mode, where the memory determines logic states of signals based on a second voltage reference setting in a second register of the memory, adjust the second voltage reference setting based on first verification data of the programmable circuitry and second verification data of the memory, and after verification of the second voltage reference setting based on the first verification data and the second verification data, store the second voltage reference setting in a first register of the memory.

Example 10 includes the non-transitory machine readable storage medium of example 9, wherein the first verification data includes a clock signal and wherein the second verification data includes a measurement of a pulse width of the clock signal by the memory.

Example 11 includes the apparatus of any one or more of examples 9-10, wherein the first verification data includes a pseudo randomly generated number and wherein the second verification data includes a comparison of the pseudo randomly generated number and the first verification data by the memory.

Example 12 includes the apparatus of any one or more of examples 9-11, wherein the programmable circuitry is to cause the memory to perform a clock synchronization operation after storing the second voltage reference setting in the first register.

Example 13 includes the apparatus of any one or more of examples 9-12, wherein the programmable circuitry is to issue a first command to a first data lane and a second data lane of a plurality of data lanes of the memory to cause the memory to enter the training mode.

Example 14 includes the non-transitory machine readable storage medium of example 13, wherein the memory samples the first data lane and the second data lane when a second rising edge of a clock signal associated with the programmable circuitry occurs.

Example 15 includes the apparatus of any one or more of examples 13-14, wherein adjusting the second reference voltage setting includes issuing at least one of a second command or a third command to the first data lane and the second data lane.

Example 16 includes the apparatus of any one or more of examples 13-15, wherein adjusting the second reference voltage setting is further based on a verification signal from a third data lane of the plurality of data lanes of the memory.

Example 17 includes a method comprising causing a memory to enter a training mode, where the memory determines logic states of signals based on a second voltage reference setting in a second register of the memory, adjusting the second voltage reference setting based on first verification data of a host controller and second verification data of the memory, and after verification of the second voltage reference setting based on the first verification data and the second verification data, storing the second voltage reference setting in a first register of the memory.

Example 18 includes the method of example 17, wherein the first verification data includes a clock signal and wherein the second verification data includes a measurement of a pulse width of the clock signal by the memory.

Example 19 includes the method of any one or more of examples 17-18, wherein the first verification data includes a pseudo randomly generated number and wherein the second verification data includes a comparison of the pseudo randomly generated number and the first verification data by the memory.

Example 20 includes the method of any one or more of examples 17-19, further including performing a clock synchronization operation after storing the second voltage reference setting in the first register.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
memory including a first register including a first voltage reference setting and a second register including a second voltage reference setting; and
at least one processor circuit coupled to the memory, the at least one processor circuit configured to:
cause the memory to enter a training mode, where the memory determines the logic states of the signals based on the second voltage reference;
adjust the second voltage reference setting based on first verification data of the at least one processor circuit and second verification data of the memory; and
after verification of the second voltage reference setting based on the first verification data and the second verification data, store the second voltage reference setting in the first register.

2. The apparatus of claim 1, wherein the first verification data includes a clock signal and wherein the second verification data includes a measurement of a pulse width of the clock signal by the memory.

3. The apparatus of claim 1, wherein the first verification data includes a pseudo randomly generated number and wherein the second verification data includes a comparison of the pseudo randomly generated number and the first verification data by the memory.

4. The apparatus of claim 1, wherein one or more of the at least one processor circuit is to cause the memory to perform a clock synchronization operation after storing the first voltage reference setting in the first register.

5. The apparatus of claim 1, wherein the one or more of the at least one processor circuit is to issue a first command to a first data lane and a second data lane of a plurality of data lanes of the memory to cause the memory to enter the training mode.

6. The apparatus of claim 5, wherein the memory samples the first data lane and the second data lane after a second rising edge of a clock signal associated with the at least one processor circuit occurs.

7. The apparatus of claim 5, wherein one or more of the at least one processor circuit is to issue at least one of a second command or a third command to the first data lane and the second data lane to adjust the second reference voltage.

8. The apparatus of claim 5, wherein one or more of the at least one processor circuit is to adjust the second reference voltage setting based on a verification signal from a third data lane of the plurality of data lanes of the memory.

9. A non-transitory machine readable storage medium comprising instructions to cause programmable circuitry to:
cause a memory to enter a training mode, where the memory determines logic states of signals based on a second voltage reference setting in a second register of the memory;
adjust the second voltage reference setting based on first verification data of the programmable circuitry and second verification data of the memory; and
after verification of the second voltage reference setting based on the first verification data and the second verification data, store the second voltage reference setting in a first register of the memory.

10. The non-transitory machine readable storage medium of claim 9, wherein the first verification data includes a clock signal and wherein the second verification data includes a measurement of a pulse width of the clock signal by the memory.

11. The non-transitory machine readable storage medium of claim 9, wherein the first verification data includes a pseudo randomly generated number and wherein the second verification data includes a comparison of the pseudo randomly generated number and the first verification data by the memory.

12. The non-transitory machine readable storage medium of claim 9, wherein the programmable circuitry is to cause the memory to perform a clock synchronization operation after storing the second voltage reference setting in the first register.

13. The non-transitory machine readable storage medium of claim 9, wherein the programmable circuitry is to issue a first command to a first data lane and a second data lane of a plurality of data lanes of the memory to cause the memory to enter the training mode.

14. The non-transitory machine readable storage medium of claim 13, wherein the memory samples the first data lane and the second data lane when a second rising edge of a clock signal associated with the programmable circuitry occurs.

15. The non-transitory machine readable storage medium of claim 13, wherein adjusting the second reference voltage setting includes issuing at least one of a second command or a third command to the first data lane and the second data lane.

16. The non-transitory machine readable storage medium of claim 13, wherein adjusting the second reference voltage setting is further based on a verification signal from a third data lane of the plurality of data lanes of the memory.

17. A method comprising:
causing a memory to enter a training mode, where the memory determines logic states of signals based on a second voltage reference setting in a second register of the memory;
adjusting the second voltage reference setting based on first verification data of a host controller and second verification data of the memory; and
after verification of the second voltage reference setting based on the first verification data and the second verification data, storing the second voltage reference setting in a first register of the memory.

18. The method of claim 17, wherein the first verification data includes a clock signal and wherein the second verification data includes a measurement of a pulse width of the clock signal by the memory.

19. The method of claim 17, wherein the first verification data includes a pseudo randomly generated number and wherein the second verification data includes a comparison of the pseudo randomly generated number and the first verification data by the memory.

20. The method of claim 17, further including performing a clock synchronization operation after storing the second voltage reference setting in the first register.
